(19) United States
(12) Patent Application Publication
(10) Pub. No.: US 2002/0046116 A1
(43) Pub. Date: Apr. 18, 2002

(54) System and method for loyalty program distribution and settlement

(76) Inventors: William Hohle, Salt Lake City, UT (US); Neil Douglas, Salt Lake City, UT (US); Corinne Ng, New Yrok City, NY (US)

Correspondence Address: Thomas J. Finn, Snell & Wilmer L.L.P., One Arizona Center, 400 East Van Buren, Phoenix, AZ, 85004-2202, US

(21) Appl. No.: 09/950,311

(22) Filed: Sep. 10, 2001

Related U.S. Application Data
(60) Provisional application No. 60/231,489, filed on Sep. 8, 2000.

(51) Int. Cl. G06F 17/60

(52) U.S. Cl. 705/14; 705/39

(57) ABSTRACT

A system and method for facilitating the distribution and settlement of electronic loyalty programs is described. The system facilitates the distribution of electronic punch card loyalty programs from an offerer, such as a product manufacturer, to an end-user and/or retailer. The user downloads the electronic punch card to a loyalty applet maintained on a microchip-enabled device such as a smart card. This smart card may then be used at various retailers to take advantage of the offerer's loyalty program. Alternatively, the host system may maintain the loyalty punch card without downloading to the user and provide access to a retailer upon the occurrence of a transaction with the user. The retailer is configured to recognize the presence of a loyalty punch card, process loyalty program information and interact with a host loyalty server system to update loyalty program data. A host system computerized clearing house captures loyalty program data and processes this data for settlement (i.e., invoices offerers and pays retailers) so as to extend the loyalty program relationship from the non-point-of-sale offerer to the end-user through a variety of retailer establishments.

### CROSS REFERENCE TO RELATED APPLICATIONS

This application claims priority to, and the benefit of, U.S. provisional application, Ser. No. 60/231,489, filed Sep. 8, 2000 which is hereby incorporated by reference.

### FIELD OF INVENTION

The present invention relates generally to a loyalty program, and more particularly, to a system and method for facilitating the computerized distribution and settlement of loyalty program data.

### BACKGROUND OF THE INVENTION

Loyalty programs are designed in various forms and include various functions. Traditional loyalty programs range from discount coupons to paper punch card offers. A typical coupon program utilized by most grocery store establishments, for example, involves a merchant, distributor or manufacturer placing coupons in magazines, newspapers, coupon books and the like. These coupons may offer discounts, rebates, etc., to encourage the purchase of a particular manufacturer's product or to visit a particular merchant retailer. In a traditional coupon program, a consumer clips a coupon from an advertisement and presents the coupon to a retailer for redemption. The retailer fulfills the coupon offer and retains the physical coupon. If the coupon is a retailer-issued coupon, external clearing house systems are not needed. If, however, the coupon was issued by a manufacturer (e.g., a manufacturer discount), the retailer must obtain reimbursement from the manufacturer. This reimbursement process is typically facilitated by a clearing house process where the coupon is presented to a clearing house which in turn forwards it to the proper manufacturer for payment. Upon receipt of the coupon, the manufacturer pays a cash equivalent value of the coupon, a redemption fee and/or other appropriate fees.

A typical punch card or coupon program involves providing existing customers with an incentive to return to a store to realize a particular savings on a product. The traditional paper punch card may provide, for example, that after purchasing 9 items of product A (9 punches), the 10th one is free. One problem with the traditional coupon scheme is that the redemption rate is typically only a few percent of the coupons printed, where the unredeemed coupons represent unrealized marketing efforts and expenditures. Another problem encountered with the punch card program is the inability to solicit new customers because the punch cards are often distributed by the retailer at the retailer's physical location. Another systemic problem with both of the above loyalty programs is that both require a printed hard copy, i.e., a physical coupon or receipt. As such, the consumer typically carries around numerous coupons and/or punch cards and is required, at the point of redemption, to present each physical coupon or punch card corresponding to each product. Thus, the coupon clipping and loyalty redemption processes can be time consuming and labor intensive for both the consumer and the retailer. Additionally, physical coupons or punch cards are frequently lost. Once a coupon, or more specifically, a partially completed punch card, is lost, the punch cardholder loses some value associated with the coupon or punch card and is not able to recover this value.

While recent technology has improved on traditional loyalty programs by introducing electronic storage (e.g., smart card) and redemption capabilities, a need still exists for better loyalty program distribution and settlement. For example, smart cards are currently used by merchants for electronic storage and redemption of merchant coupons. Merchant A, for example, may provide its customers with a Merchant A smart card-enabled coupon. When the criteria for redemption is met (e.g., punch card complete), the customer is allowed to redeem the electronic coupon at any one of Merchant A's stores. These electronic smart card loyalty programs are limited, however, in that these programs can only be used within a particular merchant environment. In other words, until the present invention, it has not been possible to extend the smart card program to product manufacturers, distributors, wholesalers, and the like, who do not interface and/or sell directly to the end-consumer. As such, a need exists for a system that can improve upon existing smart card-enabled loyalty programs and extend the electronic punch card or coupon program from the end-consumer to the manufacturer.

### SUMMARY OF THE INVENTION

The present invention is a computerized loyalty program distribution and settlement system and method. An exemplary system and method enables a manufacturer of a product to offer loyalty incentives directly to the end-consumer. The loyalty program itself involves a “punch card” or coupon system, where punches are accumulated and, upon achieving some predetermined punch criteria, the electronic punch card or coupon can be redeemed. The present invention contemplates an association between the end-consumer and one or more loyalty programs offered by one or more offerers. This loyalty program association may be distributed to the user, to a retailer, or stored by the host system for access by the retailer. One embodiment contemplates downloading a loyalty program offer to a microchip-enabled device, such as a smart card. Another exemplary embodiment does not necessarily involve downloading the loyalty program offer to a user, but storing the user-selected loyalty program offers at the host system site for access by the retailer. A third embodiment contemplates pushing the user-selected loyalty program data to systems maintained by the retailer or other third-party loyalty program facilitators.

In an exemplary embodiment, a loyalty applet provides the loyalty functionality. The loyalty applet (e.g., Java applet) may include a fixed number of slots that can be used for punch card offers. For example, each punch card typically occupies one or more of the applet's slots. In an exemplary embodiment, a user downloads a loyalty applet configured with a loyalty application to a microchip-enabled device, such as a smart card. Loyalty punch card programs may be selected and downloaded by the user to the loyalty applet on the smart card. Punch cards may be deleted from the microchip due to redemption, expiration, inactivity, lack of interest, etc.

In an exemplary loyalty punch card computerized distribution system, multiple offerers (e.g., manufacturers, merchants, etc.) desiring to provide loyalty programs (e.g., punch cards) to consumers, provide punch card offers to a host computerized distribution system. The consumer is able to access this distribution system through a distributed network, such as the internet, to select from the variety of punch card offers. The consumer may then download the desired punch cards onto a microchip-enabled device, such as a smart card, that contains the loyalty applet. The consumer uses this smart card, for example, when purchasing the offerer's products from a retailer. By doing so, the consumer accumulates punches and causes a host loyalty application server system to be updated. When the particular punch card is completed, the consumer may redeem the punch card coupon according to the loyalty program requirements. The retailer provides the product (e.g., free product A) or coupon cash value (e.g., 5% discount) to the consumer and electronically submits the punch card coupon to a host computerized clearing house for settlement processing.

In an exemplary computerized clearing house system, employing for example, a loyalty settlement system, the punch card coupon is received and processed for retailer payment and offerer invoicing. A loyalty program accounts receivable system invoices the offerer for the punch card coupon and receives coupon payment and applicable fees (e.g., redemption fee, distribution fee, etc.) from the offerer. The host system may retain the distribution fee and part of the redemption fee for facilitating the clearing house functionality and forward the coupon cash equivalent payment and remaining redemption fee to the merchant.

### BRIEF DESCRIPTION OF THE DRAWINGS

Additional aspects of the present invention will become evident upon reviewing the non-limiting embodiments described in the specification and the claims taken in conjunction with the accompanying figures, wherein like referenced numerals denote like elements.

FIG. 1 illustrates an overview of an exemplary loyalty program distribution and settlement network;

FIGS. 2-3 illustrate exemplary manufacturer-offered punch card programs;

FIG. 4 illustrates a schematic diagram of an exemplary punch card distribution system of the present invention;

FIG. 5 illustrates an exemplary loyalty program applet and punch cards capable of being downloaded to a smart card;

FIG. 6 illustrates an exemplary microchip-enabled smart card;

FIG. 7 illustrates a flow diagram of an exemplary loyalty program selection and download process of the present invention;

FIG. 8 illustrates an exemplary punch accumulation and punch card coupon redemption process of the present invention;

FIG. 9 illustrates an exemplary settlement process of the present invention;,

FIG. 10 illustrates exemplary components of a loyalty settlement system; and

FIGS. 11-13 are flow diagrams illustrating exemplary processes for accumulating punches on punch cards.

### DETAILED DESCRIPTION OF EXEMPLARY EMBODIMENTS

Described herein is a loyalty program utilizing computerized loyalty program distribution and clearing house systems to extend electronic loyalty programs to offerers (e.g., manufacturers, distributors, wholesalers, etc.) who do not typically have point-of-sale relationships with the end-consumer. The present invention allows an offerer to offer an electronic loyalty program (e.g., punch card) to the end-consumer via a unique computerized distribution and clearing house system. For example, in an exemplary embodiment, a consumer downloads a manufacturer's loyalty program (e.g., electronic punch card) to a smart card over the internet. The smart card is then used to purchase the manufacturer's product at any retailer. When the punch card criteria is reached, the consumer is rewarded and issued an electronic coupon which may be redeemed according to the terms of the loyalty program. The retailer then fulfills the coupon value at the consumer's request and retains the electronic punch card coupon. In an exemplary embodiment, the retailer submits the electronic punch card coupon to a host system computerized clearing house, which facilitates the payment and invoicing reconciliation processes (i.e., loyalty settlement) for the retailer and offerer. The offerer pays the host system clearing house, who, in turn, reimburses the retailer for the coupon value. In addition, the host system and/or the retailer may charge a fee for distribution and/or redemption of the offerer's loyalty program. As further described below, it will be apparent how the present invention improves on existing electronic loyalty programs by extending consumer-based loyalty programs to non-point-of-sale offerers, such as product manufacturers, through computerized distribution and clearing house systems.

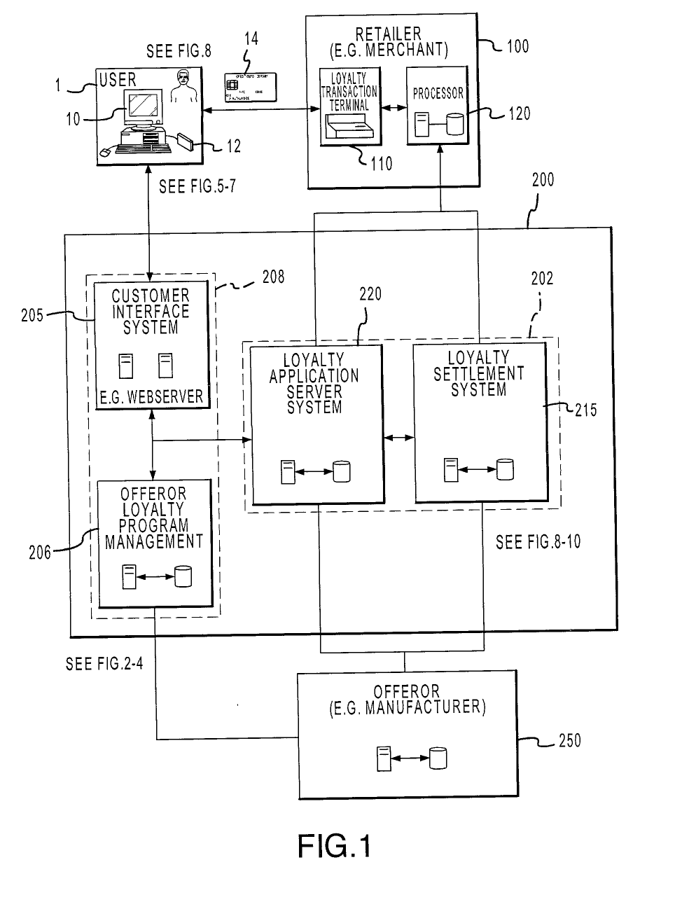

An exemplary system of the present invention is depicted in FIG. 1. Although, the present invention may be described herein in terms of functional block components, flow charts, screen shots, optional selections and various processing steps. It should be appreciated that such functional blocks may be realized by any number of hardware and/or software components configured to perform the specified functions. For example, the present invention may employ various integrated circuit components, (e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, XML, ActiveX, or the like, with the various algorithms being implemented with any combination of data structures, objects, processes, routines or other programming elements. Further, it should be noted that the present invention may employ any number of conventional techniques for data transmission, signaling, data processing, network control, and the like. For a basic introduction of cryptography, please review a text written by Bruce Schneirer which is entitled “Applied Cryptography: Protocols, Algorithms, And Source Code In C,” published by John Wiley & Sons (second edition, 1996), which is hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a loyalty application.

Turning now to exemplary components of the present invention, a loyalty host system 200, as depicted in FIG. 1, serves as the distribution and clearing house hub for the present invention. This system involves the user 1 (e.g., consumer), any retailer 100 and any offerer 250 communicating loyalty program data to and from the host loyalty system 200 to effect the loyalty punch card distribution, punch accumulation, redemption and settlement aspects of the present invention.

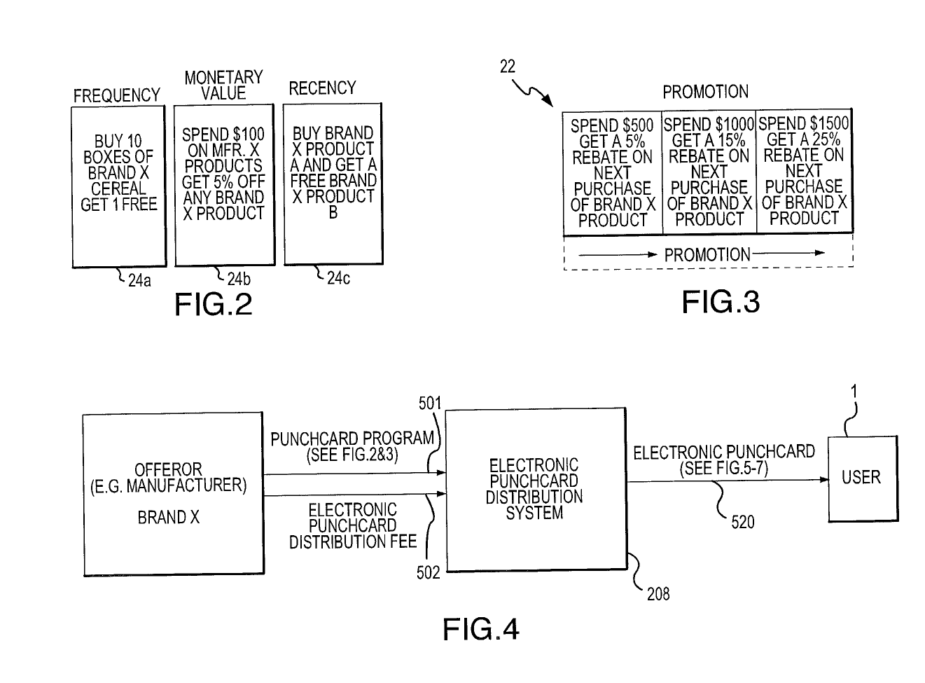

The offerer 250, as contemplated by this invention, is any entity (e.g., manufacturer, merchant, service provider, wholesaler, distributor, etc.) providing any type of electronic or computer-facilitated loyalty program offer. An exemplary offerer is a product manufacturer, who offers a variety of loyalty programs. As depicted in FIG. 2, exemplary programs may be designed, for example, to reward customers based on recency of purchase 24c, frequency of purchase 24a and/or monetary value of purchase 24b. An exemplary program may provide that (1) if a user 1 purchases 10 boxes of brand x cereal, the user 1 gets one free (frequency); (2) if user 1 spends $100 on manufacturer X's products, the user 1 gets a 5 percent discount (monetary value); (3) if user 1 buys manufacturer X's products within 10 days, the user 1 gets a 10 percent discount (recency). In an exemplary embodiment, each of these loyalty programs are embodied in an electronic punch card that can be downloaded to loyalty applets maintained on a user's smart card 14. The loyalty program may also be a progressive loyalty system, where the reward is promoted each time a new milestone is reached. For example, as shown in FIG. 3, the user 1 may decline the five percent reward after spending $500 waiting instead until $1500 is spent to recognize a 25 percent discount reward. These punch card programs may be developed by the host system 200 (FIG. 1) or may be separately developed by the offerer 250. As shown in FIG. 4, the punch card program is uploaded to the electronic punch card distribution system 208 (STEP 501). To facilitate the distribution process, the host system 200 may be configured to charge the offerer 250 a distribution fee (STEP 502).

Returning to FIG. 1, a user 1, as defined herein, includes any entity, person, business, software and/or hardware embodiment utilizing any one of a variety of electronic loyalty programs. The user 1 includes transaction, loyalty, charge and credit cardholders, consumers, customers, purchasers, and/or the like. The user 1 communicates with the host system 200, offerer 250 and/or retailer 100 via a communication device, which is suitably configured to access a computerized network. The user system 10 is such a communication device and may include any computerized system such as a personal computer, personal data assistant, automated teller machine, electronic kiosk, wireless web tablets, RFID transponder, and/or the like. In an exemplary embodiment, and as shown in FIG. 1, the user system 10 is a personal computer that is suitably configured with, or may communicate with, a smart card reader 12 capable of reading data from and writing to a smart card 14.

“Smart card” 14, as defined herein includes any type of microchip-enabled device or processing system. As such, it should be appreciated that any microchip-enabled device, such as a wireless phone, personal data assistant (PDA), web tablet, transponder and/or the like is contemplated by this invention. The smart card 14 may include any loyalty, transaction, authentication, and/or financial instrument (e.g., charge card, credit card, loyalty card, identification card, stored value card, and/or the like) that is capable of storing, generating, and/or transmitting data and application programs. An exemplary smart card 14 is the credit card sized plastic card depicted in FIG. 6. The smart card 14 may be issued to the user 1 by the host system 200, the retailer 100, the offerer 250, or any other third party. In an exemplary embodiment, a smart chip 16 (also known as a microchip) is affixed to the smart card 14 and may provide not only memory capacity, but computational capability as well. The self-containment of the smart card 14 makes it resistant to attack because it does not need to depend upon potentially vulnerable external resources. Smart cards 14 can be used to facilitate both online and offline transactions.

A typical smart card 14 may function separately as a credit card in addition to having the capability of downloading Java applets to a microchip 16. For example, the microchip-embedded Blue card from American Express™ functions as a credit card, but also has affixed thereto a microchip that is configured to communicate with a smart card reader 12. Exemplary embodiments of the present invention utilize contact and/or contactless smart cards 14. A contactless smart card 14 is configured with a smart chip 16 with an antennae embedded in it which, when activated by a magnetic field, communicates with a smart chip-enabled user 10 or merchant 11 terminal. A contact smart card 14 is configured with contacts to physically communicate with the smart card reader 12 when inserted. Although an exemplary embodiment of this invention contemplates a microchip enabled smart card 14, other readable and/or read/write data storage and retrieval means are possible, e.g., optical scanner, bar code, bar code reader, personal digital assistant, cellular phone, and/or the like. As such, it may be desirable for some embodiments to utilize a bar code and bar code reader or other similar, yet alternative means of storing and reading data.

As noted above, the smart card 14 includes any transaction and/or financial instrument such as loyalty cards, gift cards, stored value cards, and/or the like. For more information on loyalty systems, smart card systems, transaction systems, electronic commerce systems and digital wallet systems, see, for example, a Method and System for Using Loyalty Points as disclosed in U.S. Ser. No. 09/834,478, filed on Apr. 13, 2001, the Shop AMEX™ system as disclosed in U.S. Ser. No. 60/230,190, filed on Sep. 5, 2000; a digital wallet system as disclosed in U.S. Ser. No. 09/652,899, filed on Aug. 31, 2000; a stored value card as disclosed in U.S. Ser. No. 09/241,188, filed on Feb. 1, 1999; a system for facilitating transactions using secondary transaction numbers as disclosed in U.S. Ser. No. 09/800,461, filed on Mar. 7, 2001; U.S. Ser. No. 09/734,098, filed on Dec. 11, 2000; and smart card systems as disclosed in U.S. Ser. No. 60/232,040, filed on Sep. 12, 2000; and U.S. Pat. Nos. 5,742,845, 5,898,838, and 5,905,908, owned by Datascape, all of which are herein incorporated by reference.

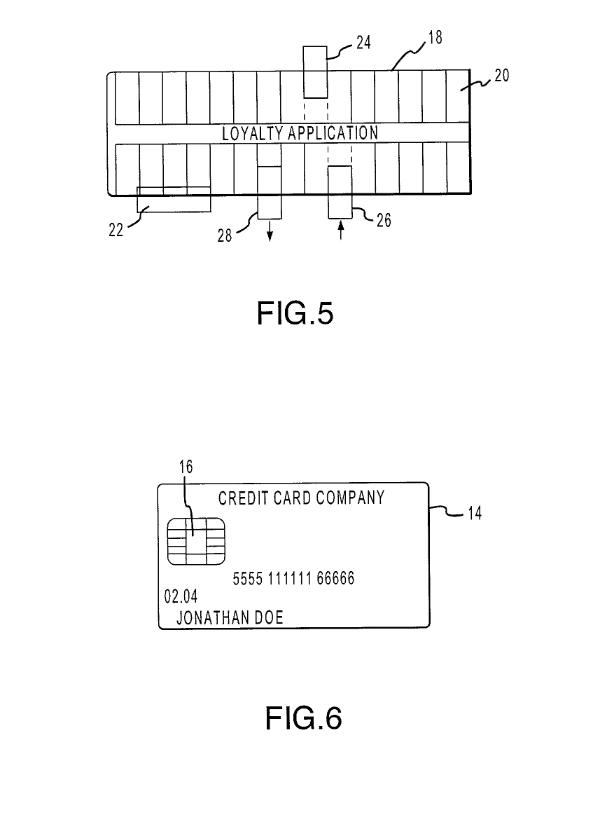

An exemplary loyalty application is configured as a downloadable Java (or similar) applet. The loyalty applet 18 (FIG. 5) contemplates any downloadable application implementing the loyalty program functionality described herein. The loyalty applet 18 is able to support a single and/or a multi-tier environment and should preferably be able to coexist with other applets or applications that may be stored on the smart card 14 or other terminal devices. An exemplary loyalty applet 18 has the ability for the loyalty program to be set and maintained using, for example, “Recency, Frequency, and Monetary” (RFM) parameters. The loyalty applet 18 will generally hold as many slots 20 for electronic punch cards 24 as space will allow. The loyalty applet 18 is configured to point to an offerer's loyalty program, where the user's identification is keyed to the particular offerer loyalty program. As illustrated in FIG. 5, a multi-tier punch card 22 may occupy several slots. Punch cards may be added 26 or deleted 28 by the user, host system and/or retailer depending on loyalty program configurations. A punch card may being removed from a slot due to punch card completion, expiration, change in program, inactivity, lack of interest, etc. As defined herein, “coupon” and “electronic punch card” are loyalty program offers and may be used interchangeably throughout this description, where a coupon should generally be understood to be a completed, and therefore redeemable, electronic punch card 24. Although one embodiment generally provides for loyalty applets that do not exceed 4K for Multos and Java smart cards, other configurations exceeding 4K are contemplated using the same or similar card formats.

As illustrated in FIGS. 2, 3 and 5, exemplary punch cards 24 of the present invention may take many forms. An exemplary loyalty program embodiment is directed to a computer-implemented electronic punch card system and entails the allocation of “points” or “punches” based on a variety of user actions, such as one or more visits to a participating retailer, purchase of one or more products or services at one or more retailers, purchase of qualifying dollar amounts, and/or the combination of other desired consumer behaviors.

In an exemplary embodiment, although the punches may be maintained on the smart card 14 (similar to the traditional paper punch cards), individual transactions may be conducted offline using the smart card 14 to store the data. In an exemplary embodiment, punch card transaction data is transmitted to the host system 200 by the retailer 100 and/or the user 1 and securely stored. As discussed later, this data is then transmitted in batch to a server (loyalty settlement system 218) for processing, statementing, and billing. If a card is lost or stolen, loyalty transactions (i.e., punch card punches) can be recreated at the server and unused value replaced to the user 1.

Although one embodiment downloads the punch card 24 to the user's microchip-enabled device such as a smart card 14, in an alternative embodiment, this loyalty program information may instead be stored by the host system 100 for access by the retailer 100. In this embodiment, the host system 200 associates loyalty program punch cards with individual users 1 by any number of identification means (e.g., transaction card number, social security number, passcode, etc.). At the time of the transaction with a particular user 1, the user 1 provides the retailer 100 with identification or authentication information, and the retailer 100 communicates with the host system (e.g., via a distributed network) to access loyalty programs associated with the user 1. The retailer 100 is then able to compare the loyalty punch cards 24 with the products purchased and process accordingly. In another exemplary embodiment, the host system 200 pushes loyalty punch card 24 information associated with one or more users 1 to participating retailers 100.

The retailer 100 is any product or service provider capable of facilitating the loyalty program functionality herein described. As such, the retailer 100 may be configured with any hardware or software system capable of receiving, via an actual or virtual storefront, user 1 loyalty program data. An exemplary retailer 100 comprises a loyalty terminal 110 and a data processing system 120. The loyalty terminal 110 may be a loyalty program-specific terminal or may be a modified point-of-sale (POS) or electronic cash register (ECR) terminal capable of receiving loyalty program data. An exemplary loyalty terminal 110 is configured to read the user's microchip enabled device (e.g., smart card) and/or communicate with the host system to retrieve loyalty punch card 24 data and may also be configured to update or write to the microchip-enabled device to reflect recent purchases. The loyalty terminal may or may not be separately connected to a POS terminal or other data processing systems. Additionally, the loyalty terminal 110 may also be configured to capture purchase data, including product price, product sku (i.e., product name), date of purchase or redemption, retailer identifier (SE#) and/or the like. An exemplary loyalty terminal is configured with a smart card reader device for reading loyalty punch card data from the smart card 14, modifying smart card 14 to reflect transactions, recognizing when a completed punch card, and fulfilling the punch card reward at the user's 1 request. The data processing system 120 may be located within or outside of the physical retailer environment and is configured to process product and transaction information, such as retrieval of product information from a product database and comparison with loyalty program information captured from the user's smart card 14. As one skilled in the art will appreciate this system may interface with the loyalty terminal 110 or may be combined within one retailer system. In an exemplary embodiment, the loyalty terminal 110 captures the loyalty information and passes it to the retailer data processing system to compare with product information. The data processing system 120 is configured to communicate with the host electronic clearing house system 202 to facilitate the settlement of the loyalty program coupon.

The host system 200 is suitably configured to manage the loyalty program distribution and settlement processes. In an exemplary embodiment shown in FIG. 1, the host system 200 comprises, inter alia, (1) a loyalty program distribution system 208 to distribute loyalty programs from the offerer 250 to the user 1, and (2) a loyalty program clearing house system 202 to facilitate settlement (payment and invoicing) between the retailer 100 and the offerer 250. The distribution system 208 comprises a customer interface system 205 and an offerer loyalty program management system 206. The customer interface system 205 generally facilitates communication between the host system 200 and the user 1, the retailer 100 and/or the offerer 250. The offerer loyalty program management system 206 generally stores, formats and processes the loyalty programs for the various offerers 250 (e.g., manufacturers) who may want to offer loyalty or incentive programs to the end-consumer. An exemplary clearing house 202 comprises, inter alia, a loyalty settlement system 215 and a loyalty application server system 220. The loyalty settlement system 215 generally facilitates the settlement of loyalty program coupons and payment between redeeming retailers 100 (e.g., merchants) and offerers 250, including the invoicing and payment of distribution and redemption fees.

The computerized distribution system 208 includes any method, device or means for distributing the offerer's loyalty programs to users 1 or retailers 2. An exemplary distribution system 208 comprises a customer interface system 205 that facilitates communication between the offerer loyalty program management system 206 and the user 1. As shown, the customer interface system 205 may also be suitably connected to the loyalty application server system 220 to facilitate communication between the application server system 220 and the user 1. The customer interface system 205 may include any server system connected to any type of distributed network 20, such as the internet. A web server complex is one example of a customer interface system 205, through which the user 1, retailer 100 and/or offerer 250 may communicate with the various loyalty system to perform any number of tasks, such as to view loyalty accounts, modify loyalty accounts, download loyalty applets, download loyalty punch cards, generate reports, and/or the like. It should be appreciated that this invention contemplates any means for communicating, such as through the internet, intranet, WAP, satellite, wireless networks, beaming technology such as Bluetooth, etc.

The offerer loyalty program management system 206 is configured in an exemplary embodiment to allow the offerers to create new offers, view offers, generate reports on offers, modify offers, etc. As such, the management system 206 may be suitably connected to the loyalty application server system 220 to retrieve loyalty program data pertaining to a particular offerer 250, such as how many loyalty punch cards have been issued, what type of programs are popular, how many coupons have been redeemed, how many punches have been issued, which retailers 100 are utilized the most, etc.

The loyalty application server system 220 is configured in an exemplary embodiment as the hub for processing loyalty program data. As such, the loyalty server system 220 will contain all data about the loyalty offers, offerers (e.g., manufacturers, merchants, etc.) and agreed upon fees and payment schedules set up with each offerer for each offer. The loyalty server system 220 will also receive and store all loyalty related transactions (e.g., setup, punch, redemption, etc.). Upon processing each transaction, the loyalty server system 220 will calculate any applicable fee for that transaction/offer/offerer which will be stored within the loyalty server system 220 database and linked to the corresponding transaction.

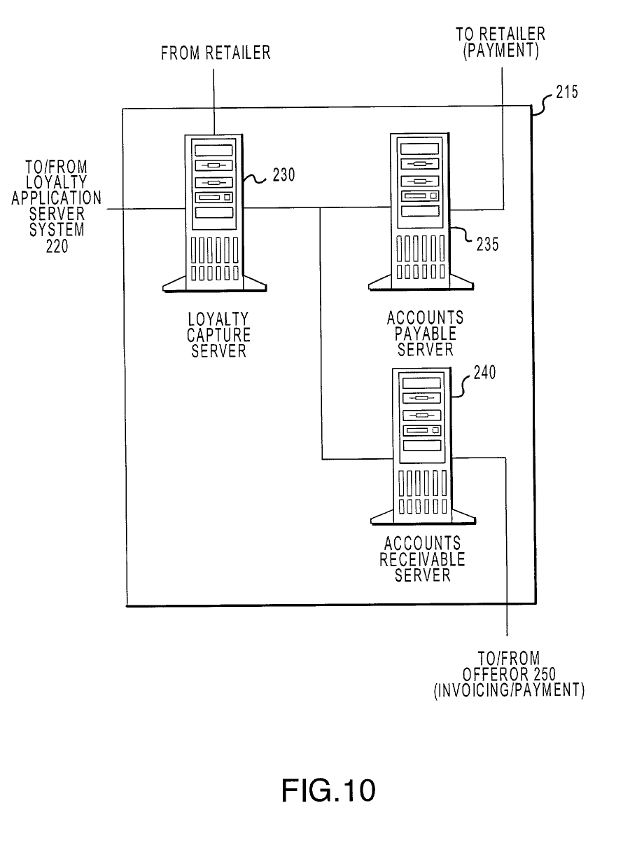

The loyalty settlement system 215, in an exemplary embodiment, serves as the core system for the clearing house activity. The settlement system 215 is configured in an exemplary embodiment, to sweep the loyalty database, which may be maintained in the loyalty server system 220, on a scheduled basis and retrieve all fees and outstanding redemption values and generate the appropriate invoices and journal entries. Fees may be due to the host system 200 from the offerer 250 for offer setup, distribution, punch/coupon redemption. Funds may be due to the retailer 100 from the offerer 250 for reimbursement of the coupon face value and for fees related to coupon redemption. The settlement system 215 will generate, distribute, track and reconcile all invoices. Monies received from the offerer 250 due to the retailer 100 will also processed by the settlement server 215, with funds distributed to the retailer. The settlement system 215 is further configured to collect overdue invoices, provide reporting data related to invoices and fees by offerer, offer, retailer and loyalty demographics. Additionally, the settlement system 215 may also be configured to produce reports identifying the outstanding liability (e.g., unredeemed coupons) for each offerer. As further depicted in FIG. 10, the loyalty settlement system 215 may be configured with a loyalty capture server 230 for capturing loyalty data and forwarding, as appropriate, to an accounts payable system 235 for paying the retailer 100 and an accounts receivable system 240 for invoicing the offerer 250. In an exemplary embodiment, the settlement system 215 may also communicate with the loyalty server system 220 and/or the offerer loyalty program management system 206 to allow the host system 200 to facilitate distribution settlement, punch transaction settlement, redemption settlement, and/or the like. For example, the distribution settlement involves tracking and reporting fees charged to offerers for downloading or pre-loading offers (i.e., charge manufacturer and/or merchant to distribute their loyalty programs) and configuring retailer 100 to accept smart card facilitated electronic punch cards. The punch transaction settlement involves the capability of tracking the punches to an electronic punch card, charging and collecting from the offerer fees for each punch activity. The redemption settlement involves charging and collecting from the offerer for each punch card redemption (i.e., completed punch card presented to retailer for redemption).

Turning to the exemplary processes of the present invention, as depicted in FIG. 4, an offerer 250 first creates an offer (e.g., electronic punch card) and loads this electronic punch card to the host electronic punch card distribution system 208 (STEP 501). Alternatively, the host system is capable of creating electronic punch cards for the offerers. To facilitate the distribution of the electronic punch card to the user 1, the host system may charge a distribution fee (STEP 502). The present invention contemplates a number of embodiments for distributing the electronic punch cards for use by the user 1. In an exemplary embodiment, an offerer's loyalty punch card 24 may be downloaded or preloaded to a microchip-enabled device, such as a smart card 14. To use the loyalty program punch card 24, the user 1 presents the smart card 14 to a retailer 100. The smart card 14 is swiped through the loyalty terminal 110 and the retailer system (e.g., loyalty terminal 110 or processor 120) compares this loyalty program punch card on the smart card 14 with products to be purchased to assess the applicability of loyalty punch card offers. The loyalty terminal 110 communicates with the microchip 16 on the smart card 14 to access the loyalty program punch card 24 and update the punch card 24 to reflect the applicable purchase. The retailer 100 then accesses a host system 200 to update the associated loyalty program stored on the host system 200. The loyalty program data is managed, as previously described, to provide reporting, tracking, and other desired data management functions. Completed punch cards or coupons are then settled with the offerer.

In another embodiment, it is not necessary for the user 1 to download the punch card 24 to a microchip-enabled device. Rather, the punch card 24 is stored within the host system and associated with the user 1 by some identification indicia (e.g., charge card number, social security number, passcode, etc.). This identification means may be established via any type of identifying or authenticating means, including, for example, biometric identification (e.g., voice, dna, fingerprint, retinal, etc.). The retailer 100, at the point of transaction, instead of, or in addition to, communicating with and updating the microchip-enabled device (as described herein), communicates user 1 authentication or identification information to the host system 200 to access applicable loyalty program information. A third embodiment contemplates pushing the user-selected punch card programs from the host system to participating retailers in addition to, or in lieu of, downloading punch cards to the user 1.

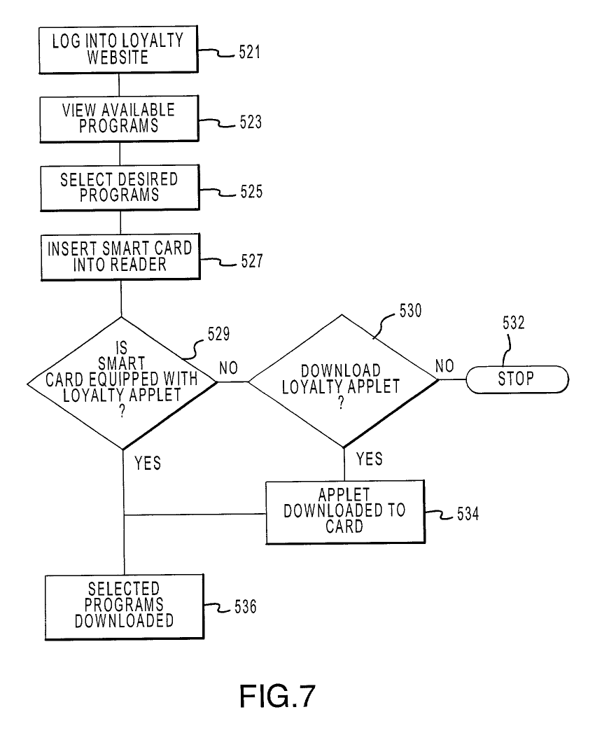

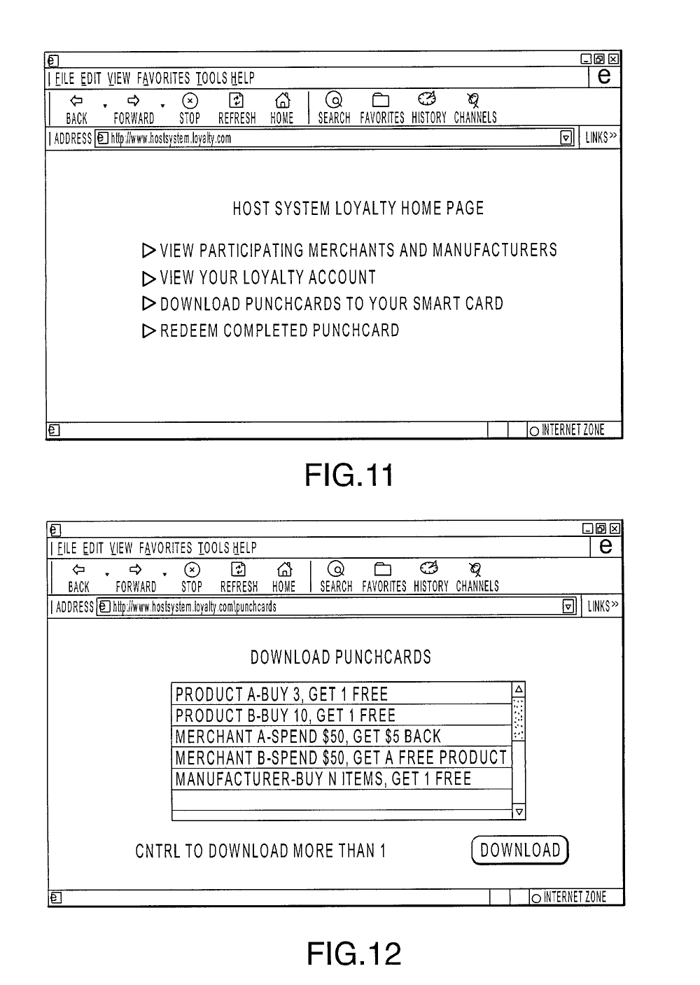

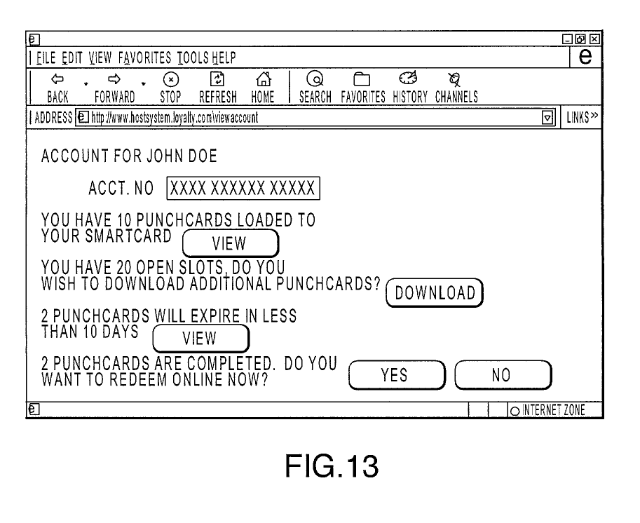

Describing further an exemplary process of downloading punch cards 24 to the user's smart card 14, the user 1, logs onto a website (FIG. 7, STEP 521) to view and download the desired electronic punch card programs (FIG. 7, STEP 523), as depicted by the exemplary screen shots in FIGS. 11-13. The user 1 selects the desired punch card programs (FIG. 7, STEP 525), inserts his or her smart card 14 into the smart card reader 12 (STEP 527). The host system communicates with the microchip 16 to determine if the smart card is already equipped with a loyalty applet (STEP 529). If the user 1 has not previously downloaded the loyalty application, the user 1 is asked if he or she would like to download the loyalty applet (STEP 530). If the user 1 does not wish to proceed the process is stopped (STEP 532). If the user 1 selects the download applet option, the applet is downloaded to the user's smart card 14 (STEP 534). Once the smart card 14 contains the loyalty applet, the selected programs are then downloaded to the smart card 14 (STEP 536).

It should be appreciated that a variety of means exist for delivering the loyalty application from the host system 200 to a smart chip 16 (microchip). Exemplary means for delivering the loyalty application include pre-loading the software and/or hardware on the smart chip-enabled device; delivery over a distributed network, such as the Internet, to a smart chip-enabled user and/or merchant terminal; delivery over a wireless network to a suitably-configured microchip-enabled device; delivery to the smart chip via a direct communication link with a merchant kiosk, etc.

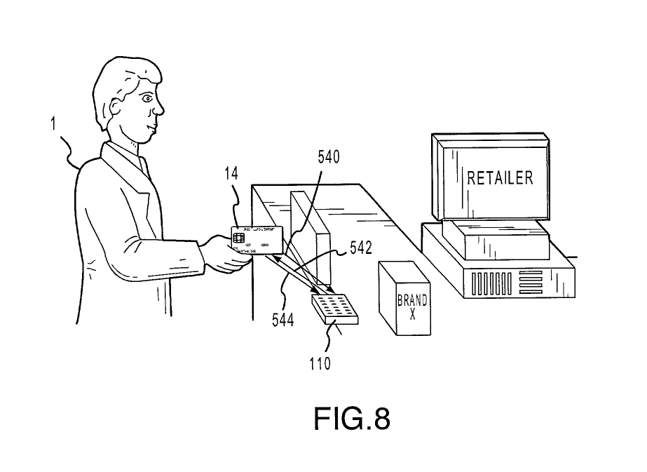

To use the smart card 14, the user 1 may purchase items at retailer 100. When the user 1 proceeds to the checkout, the smart card 14 is presented to the retailer 100. The retailer loyalty terminal 110 (FIG. 8) reads the loyalty punch card data from the smart card 14, and interacting with the data processing system 120 if necessary, determines if items purchased or the monetary value qualifies the user 1 for a “punch” (STEP 540). If a selected product is recognized as being associated with a punch card, the loyalty terminal 110 communicates with the smart card 14 to increment or decrement the punch card to reflect the transaction (STEP 542). This process may happen a number of times until the punch card is completed, when, upon completion, the loyalty terminal recognizes that the punch card is completed and informs the user 1. The user 1 is provided the opportunity to redeem the loyalty punch card coupon for the free product or coupon value (e.g., 5% off). If the user 1 desires to redeem the punch card coupon, the loyalty terminal communicates with the smart card 14 to retrieve and capture the punch card coupon data for processing and settlement (STEP 544). Throughout this process, in an exemplary embodiment, the loyalty terminal 110 is configured to communicate with an data processing system 120, which captures loyalty punch and punch card coupon data, transaction data (e.g., cost, product sku, etc.). The data processor 120 communicates with the host system 200 (e.g., loyalty server system 220, loyalty settlement system 215, etc.) to update host system loyalty program database files, thus ensuring that the loyalty program is preferably up-to-date after every punch transaction. The host system 200 maintains user 1 and offerer 250 loyalty program data that may be accessed by the offerer 250, the user 1, and/or the retailer 100 to track, report, modify program data as desired.

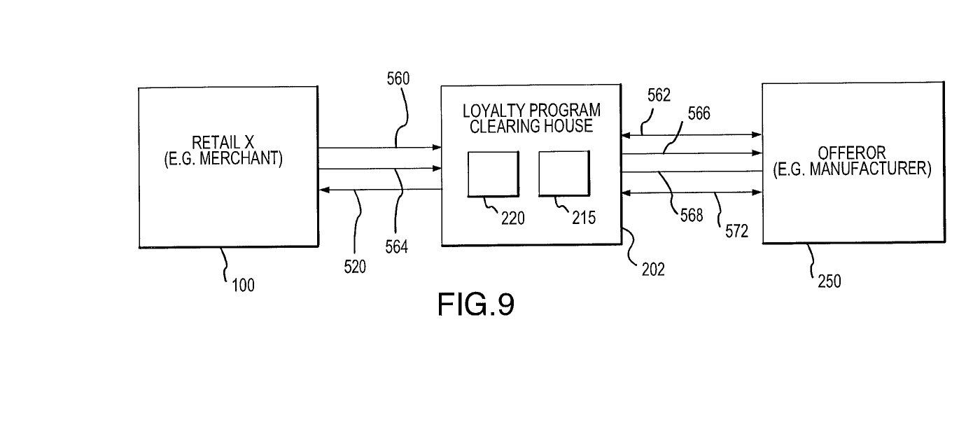

FIG. 9 illustrates an exemplary electronic clearing house that processes loyalty program data to ensure that the offerer 250 is able to track the effectiveness of the offerer's loyalty program, that the retailer 100 is reimbursed for the offerer reward provided to the user 1, and all parties are compensated for their distribution and redemption efforts. Accordingly, the retailer 100 typically batch processes punch data for every punch card transaction and communicates this information to the host system (STEP 560). Settlement statementing may be configured to charge the offerer for every punch processed (STEP 562). When a punch card is completed at the retailer 100, the retailer 100 provides the user 1 with the appropriate offerer reward (e.g., free product, discount, etc.). This punch card coupon is captured and sent to the host system clearing house 202 for clearing and settlement. The clearing house 202 systems, such as the loyalty capture server 230, accounts payable server 235, and the accounts receivable server 240, ensure that the offerer 250 is invoiced (STEP 566), the invoice is paid by the offerer (STEP 567) and the retailer is reimbursed for the coupon value (STEP 570). Throughout the distribution and settlement process, in an exemplary embodiment, the offerer is able to track all punch activity by communicating with the host system 200 (STEP 572).

Although this invention has been described in language specific to structural features and/or methodological steps, it is to be understood that the invention defined in the appended claims is not necessarily limited to the specific features or steps described. Rather, the specific features and steps are disclosed as exemplary forms of implementing the claimed invention. Accordingly, the scope of the invention should be determined by the appended claims and their legal equivalents, rather than by the examples given above. For example, the steps recited in any of the method or process claims may be executed in any order and are not limited to the order presented in the claims.

What is claimed is:

1. A loyalty program settlement method, comprising the steps of:
facilitating communication with a retailer and a loyalty program offerer over a distributed network;
receiving from said retailer, loyalty program data associated with one or more loyalty programs offered by said offerer; and
processing said loyalty program data to facilitate loyalty program settlement.

2. The method of claim 1, further comprising the step of storing said loyalty program data in a host system database.

3. The method of claim 2, further comprising the step of managing said loyalty program data in a loyalty server system to facilitate loyalty program tracking, reporting and settlement.

4. The method of claim 1, wherein said loyalty program data comprises an electronic loyalty punch card coupon associated with said offerer, wherein said electronic loyalty coupon is associated with a completed loyalty program offer.

5. The method of claim 4, said processing said loyalty program data to facilitate loyalty program settlement, further comprising the steps of:
capturing said electronic coupon in an electronic clearing house system, wherein said coupon is associated with a cash equivalent value;
providing said offerer with said electronic coupon;
invoicing said offerer for said cash equivalent value;
receiving from said offerer, a payment equal to at least said cash equivalent value; and
paying retailer at least said cash equivalent value.

6. The method of claim 1, wherein said loyalty program data comprises a punch transaction data.

7. The method of claim 1, wherein said offerer is a product manufacturer.

8. The method of claim 1, wherein said communication over a distributed network is facilitated with a customer interface system.

9. The method of claim 8, wherein said customer interface system is a web server configured for communication with said retailer and said offerer over said distributed network.

10. The method of claim 1, said processing said loyalty program data to facilitate loyalty program settlement, further comprising the steps of:
invoicing said offerer for a settlement fee associated with said loyalty program data; and
paying said retailer at least a part of said settlement fee.

11. The method of claim 10, wherein the settlement fee is selected from a group of fees consisting of a distribution fee, a punch fee, and a redemption fee.

12. A loyalty program distribution method, comprising the steps of:
receiving, from at least one offerer, a plurality of loyalty program offers;
formatting said plurality of loyalty program offers into electronic punch card format capable of electronic distribution over a distributed network; and
distributing one or more of said loyalty program offers to a user.

13. The method of claim 12, further comprising the step of storing said plurality of loyalty program offers in a host system.

14. The methods of claim 12, the distributing step further comprising the steps of:
configuring a customer interface system to communicate with a user system over a distributed network, wherein said customer interface system is configured to allow said user to select from one or more of said plurality of loyalty program offers;
posting one or more of said plurality of loyalty program offers to a host system server in communication with said customer interface system; and
receiving a loyalty punch card selection from one of said plurality of users.

15. The method of claim 14, the distributing step further comprising the steps of:
prompting said user to communicate data from a microchip-enabled device over said distributed network;
determining if said microchip-enabled device is configured with a loyalty applet;
if said microchip-enabled device is configured with said loyalty applet, downloading to said microchip-enabled device said punch card offer selected by said user; and
if said microchip-enabled device is not configured with said loyalty applet, downloading (1) said loyalty applet to user's microchip-enabled device, and (2) said loyalty punch card offer.

16. The method of claim 15, wherein the distributed network is the internet.

17. The method of claim 15, wherein said microchip-enabled device is a smart card.

18. The method of claim 15, wherein the user system is a personal computer configured with a smart card reader.

19. The method of claim 15, said microchip-enabled device is anyone of the following devices: PDA, transponder, electronic kiosk, personal computer, retailer loyalty terminal, point of sale device, and electronic cash register.

20. A loyalty program distribution method, comprising the steps of:
receiving, from at least one offerer, a plurality of loyalty program offers;
formatting said plurality of loyalty program offers into electronic punch card format;
communicating with a user over a distributed network to obtain user's selection of one or more of said plurality of loyalty program offers; and
associating, in a host system database, said selected loyalty program offers with said user.

21. The method of claim 20, further comprising the steps of:
communicating with a retailer over a distributed network;
receiving from said retailer over said distributed network, product and user information; and
accessing said host system database to determine if said product and user information correspond to one of more loyalty programs associated with said user.

22. The method of claim 21, further comprising the steps of:
notifying said retailer of loyalty programs associated with said user; and
updating loyalty program offer to reflect retailer transaction activity.

23. The method of claim 20, further comprising the steps of:
distributing said association of said user and said selected loyalty program offers to one or more retailers.

24. A loyalty program distribution and settlement method, comprising the steps of:
retrieving an offerer's electronic punch card from a user or a host system;
comparing loyalty program information contained within said electronic punch card to the offerer's products purchased by said user; and
updating said punch card to reflect the purchase of said offerer's products.

25. The method of claim 24, further comprising the steps of:
determining if punch card criteria has been met;
if criteria has been met, providing said user the punch card reward; and
communicating coupon to said host system, over a distributed network, to facilitate settlement.

26. The method of claim 24, further comprising the steps of updating said host system to reflect punch activity.

27. A loyalty program distribution and settlement system comprising:
a computerized distribution system configured to format offerer loyalty programs for distribution over a distributed network to a user and to distribute said programs over said distributed network to said user at said user's request; and
a computerized clearing house configured to receive loyalty program data from a retailer, invoice offerer according to a first amount associated with said loyalty program data, and pay said retailer a second amount associated with said loyalty program data.
